(19) United States
(12) Patent Application Publication
(10) Pub. No.: US 2010/0032236 A1
(43) Pub. Date: Feb. 11, 2010

(54) Fall arrest system

(76) Inventors: Bruce Morris, Tiffin, OH (US); Denny Neiderkohr, Republic, OH (US); Tonya Breidenbach, Tiffin, OH (US); Tom Troiano, Sycamore, OH (US)

Correspondence Address: MARSHALL & MELHORN, LLC, FOUR SEAGATE - EIGHTH FLOOR, TOLEDO, OH, 43604, US

(21) Appl. No.: 12/462,475

(22) Filed: Aug. 4, 2009

Related U.S. Application Data
(60) Provisional application No. 61/086,179, filed on Aug. 5, 2008.

(51) Int. Cl. A62B 1/16; A62B 35/00

(52) U.S. Cl. 182/112

(57) ABSTRACT

A fall arrest system for a billboard is disclosed. The billboard may have horizontally extending ribs and vertically extending sprits. A first bracket and a second bracket, each having a horizontal portion and a vertical portion, are provided. The horizontal portion extends beyond the billboard. The vertical portion has channels for receiving the ribs therein. At least one mechanical fastener connects the brackets to the ribs. An arresting line extends from the first bracket to the second bracket.

### RELATED APPLICATIONS

This application claims the benefit of U.S. Provisional Application No. 61/086,179, filed Aug. 5, 2008, which is fully incorporated by reference herein.

### FIELD OF THE INVENTION

The present invention relates to a system for arresting falls by a human worker from any number of structures including, but not limited to, billboards.

### BACKGROUND OF THE INVENTION

It is well-known that many different types of structures are built above the ground and some may be very high off the ground. During construction of the structures, or during maintenance, repair or replacement of components of the structures, workers must be exposed to heights that, if fallen from, could result in injury or worse. Billboards are just one example of such structures.

Various means for protecting workers from falls from billboards are known. Some of these means comprise railings, specialized harnesses workers may wear, and/or lines or cables that are connected to the worker and a fixed anchor point on the structure.

The various means, including the lines or cables, have certain limitations and disadvantages. One such limitation is that the existing safety equipment often inhibits freedom of movement of the worker. Another limitation is that some safety equipment requires modification of the existing structure. Another limitation is that some equipment, while it prevents the worker from coming in contact with the ground during a fall, requires the worker to absorb all of the energy of the fall. In view of the disadvantages and limitations of the prior art designs, only some of which have been mentioned above, it would be desirable for a fall arrest system to permit maximum freedom of movement, reduce or prevent the need for modification of the existing structure and absorb some or all of the energy of a fall.

### SUMMARY OF THE INVENTION

The present invention comprises a fall arrest system for billboards and the like. In a first embodiment of the system, a billboard may have two ribs extending horizontally substantially across a rear surface. The billboard may also have at least two sprits extending vertically across the rear surface.

The system also comprises a first and a second bracket. Each bracket may comprise a horizontal portion extending substantially perpendicularly beyond the perimeter of the billboard. Each bracket may also have a vertical portion connected to the horizontal portion. The vertical portion has a plurality of channels formed therein for receiving the ribs.

An arresting line extends from the horizontal portion of the first bracket to the horizontal portion of the second bracket.

At least one mechanical fastener may be provided to extend through the vertical portions of each of the brackets. The fastener preferably has a portion for slidably engaging at least one of said ribs.

If one or more persons connected to the arresting line were to fall, the sliding action of the fastener absorbs some or all of the energy so as to prevent or reduce injury to the person. Additionally, one or more of the brackets and/or the billboard itself may deform, also to absorb energy and prevent or reduce injury.

In another embodiment of the invention, the fastener secures the bracket to at least one rib but in a manner that the fastener does not slide with respect to the rib. In this embodiment, the billboard and/or the brackets may be designed so as not to deform.

In yet another embodiment, the brackets may be connected to one another by reinforcing plates and a tube-like structure. The reinforcing plates and tube-like structure adds strength and rigidity to the system.

### BRIEF DESCRIPTION OF THE DRAWINGS

The advantages of the present invention will become readily apparent to those skilled in the art from the following detailed description when considered in the light of the accompanying drawings in which:

FIG. 1 is a schematic perspective front view of one embodiment of the present invention;

FIG. 2 is a schematic perspective rear view of the invention of FIG. 1;

FIG. 3 is a schematic perspective view of one component of the invention of FIGS. 1 and 2;

FIG. 4 is a schematic exploded view of the component of FIG. 3 taken from another angle;

FIG. 5 is a schematic perspective view of the component of FIGS. 3 and 4 installed on a billboard;

FIG. 6 is a schematic view along line 6-6 of FIG. 5;

FIG. 7 is a schematic perspective view of the component depicted in the foregoing figures in an alternative embodiment;

FIG. 8A is a schematic perspective view of the component of FIGS. 3-6;

FIG. 8B is a close-up view of the structure of FIG. 8A;

FIG. 9A is a schematic lower, perspective view of the component of FIGS. 1-6 and 8A and 8B in an installed position;

FIG. 9B is a schematic side perspective view of the component of FIG. 9A;

FIG. 10A is a schematic perspective view of the invention compatible with FIG. 7;

FIG. 10B is a close-up view of a part of the structure of FIG. 10A;

FIG. 11A is a schematic front view of the invention in an altered state;

FIG. 11B is a schematic front view of the invention without alteration;

FIG. 12A is a schematic, partial rear perspective view of the invention in the state of FIG. 11A;

FIG. 12B is a schematic, partial rear perspective view of the invention in the state of FIG. 11B;

FIG. 13 is a schematic rear view of another structure of the present invention;

FIG. 14 is a schematic side view of the structure of FIG. 13;

FIG. 15 is a schematic perspective view of the structure of FIGS. 13 and 14;

FIG. 16 is a schematic front perspective view of the structure of FIGS. 13-15 installed on a billboard;

FIG. 17 is schematic rear perspective view of the structure of FIGS. 13-15 installed on a billboard;

FIG. 18 is a schematic front view of the structure of FIGS. 13-15 installed on a billboard;

FIG. 19 is a schematic side view of the structure of FIGS. 13-15 installed on a billboard;

FIG. 20 is a schematic rear view of the structure of FIGS. 13-15 installed on a billboard; and

FIG. 21 is a schematic rear view of an alternative embodiment.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of various concepts of the present invention. Hence, specific dimensions, directions or other physical characteristics relating to the embodiments disclosed are not to be considered as limiting, unless expressly stated otherwise.

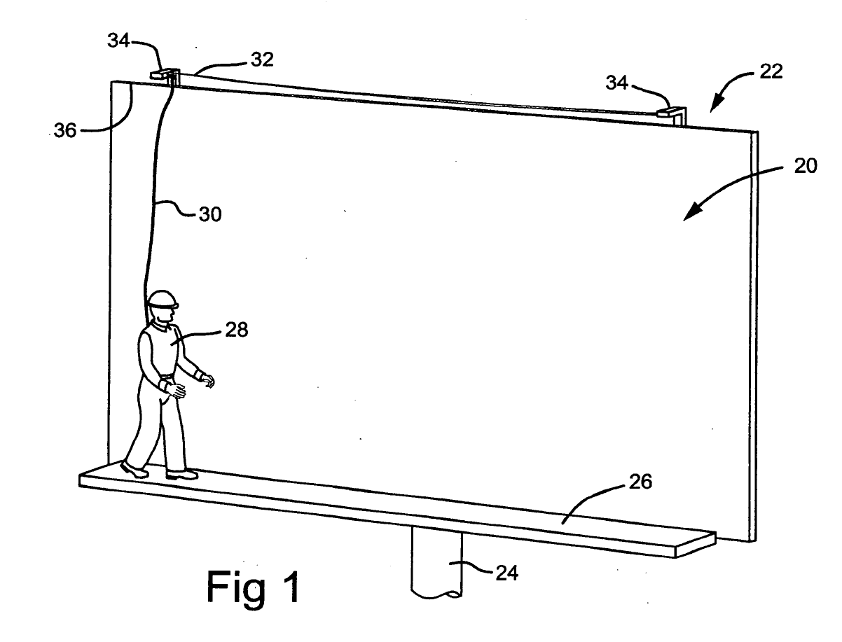

Referring now to FIG. 1, a front portion 20 of a billboard 22 is depicted. While billboard 22 is depicted as being one vehicle for the present invention, it can be readily appreciated that the invention described herein can be used with a variety of different structures and is not limited only to billboards 22.

The billboard 22 depicted in FIG. 1 can be of any type known to those skilled in the art including, but not limited to, those comprised of horizontal or vertical panels being constructed of wood, metal and/or polymer, billboards constructed without such panels, digital billboards, and/or plywood-type billboards.

Billboards are typically elevated many feet above the ground by one or more support structures. One such structure, a single vertical pole 24, is schematically depicted in FIG. 1. Other structures, such as four wooden poles, are well-known and included by reference herein.

A walk surface 26 is typically provided so that a worker 28 has access to at least the entire front portion 20 of the billboard 22 for installation, maintenance, repair and replacement of the billboard 22 as well as the signage located thereon or therewith.

The worker 28 typically wears a harness or belt to which a first line 30 is securely, but releasably, attached. The first line 30 is movably attached to a stationary second line 32 such as with a trolley, loop or other structure that permits the first line 30 to move with respect to the second line 32. The second line 32 may extend substantially above the front portion 20 so as not to hinder the view of the billboard 22.

The second line 32 is preferably attached to at least two brackets 34 extending above the upper edge 36 of the billboard 22. While the figures depict two brackets 34, others may be used for additional support.

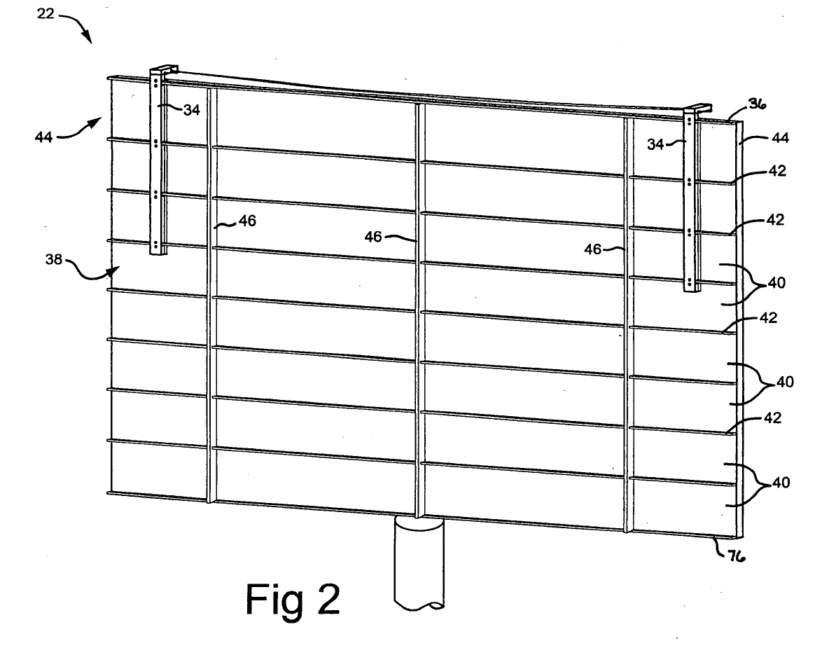

Turning now to FIG. 2, a rear portion 38 of the billboard 22 of FIG. 1 can be seen. The billboard 22 in the depicted embodiment is comprised of a series of horizontal panels 40 secured to one other to create a billboard 22 of a desired height.

One method of securing the panels 40 to one another comprises engaging a C-shaped channel (not shown) along the upper edge (not shown) of a lower panel with a complimentary shaped C-shaped channel (not shown) located along a lower edge (not shown) of an upper panel located immediately above the lower panel and so forth to create the billboard 22. Mechanical fasteners (not shown), such as screws, can be located through both of the interlocked C-shaped channels of both panels to secure the panels together. Together the two channels form horizontal ribs 42 extending substantially entirely from one side 44 of the billboard 22 to the other side 44 of the billboard 22.

In one embodiment, vertical sprits 46 of any number may also be located on the rear portion 38 of the billboard 22. The vertical sprits 46 may be spaced from one another as needed. Preferably, the horizontal ribs 42 extend continuously through openings (not shown) in the vertical sprits 46.

The two brackets 34, of which only portions could be seen in FIG. 1, can be seen more fully in FIG. 2. The brackets 34 may extend downwardly from the upper edge 36 of the billboard 22 for a predetermined distance. In the depicted embodiment, the brackets 34 both extend an equal distance down from the upper edge 36. Both brackets 34 are substantially perpendicular to the horizontal ribs 42 and parallel with the vertical sprits 46.

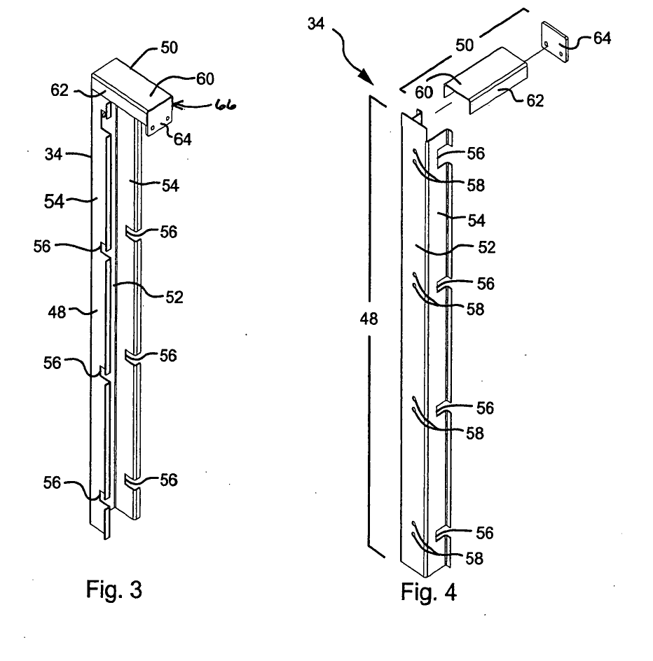

The brackets 34 may be identical in structure. One bracket 34 is depicted in FIGS. 3 and 4. While FIGS. 3 and 4, as well as other figures herein, depict one embodiment of the brackets 34, other similar brackets with similar features functioning in similar ways, are within the scope of the present invention. Thus, it should be understood that the brackets 34 are merely exemplary of preferred embodiments, and that the present invention is not limited only to the depicted and described shapes.

The bracket 34 has a vertical portion 48 and a horizontal portion 50, the vertical portion 48 preferably being greater in length than the horizontal portion 50. However, it can be readily appreciated that the horizontal portion 50 might be greater in length than the vertical portion 48. In the depicted embodiment, the vertical portion 48 and the horizontal portion 50 have a generally C-shaped cross-section. FIG. 6 also depicts the C-shaped cross-section of the vertical portion 48.

The vertical portion 48 is preferably comprised of a back portion 52 and two side portions 54. The side portions 54 may be integrally formed and unitary with the back portion 52 or they may be formed separately and joined to the back portion 52 by mechanical fasteners and/or welding.

Each side portion 54 preferably has a number of inwardly extending channels 56. The channels 56 have a complimentary shape to the horizontal ribs 42 to accept the ribs 42 therein. The channels 56 in one side portion 54 are thus vertically aligned with the channels 56 in the other side portion 54.

FIG. 4 depicts a number of apertures 58 in the back portion 52 of the bracket 34. While eight apertures 58 are depicted in the figure, any number of apertures 58 may be located in the back portion 52. A plurality of apertures permit the brackets 34 to be used interchangeably for either the upper edge 36 of the billboard 22 or a lower edge 76 of the billboard 22, or elsewhere on the billboard 22.

The horizontal portion 50 of the bracket 34 is shown separately formed from the vertical portion 48, however, this is not a requirement of the present invention. Instead, the horizontal portion 50 may be unitary with the vertical portion 48. If the two portions 48, 50 are separately formed, they may be secured to one another by mechanical fasteners and/or welding.

The horizontal portion 50 preferably has an upper portion 60 and two unitary downwardly extending portions 62 that are substantially perpendicular to the upper portion 60. The upper and downwardly extending portions 60, 62 may also be separately formed and mechanically attached, and/or welded, to each other.

A cover plate 64 may be located on a front portion 66 of the horizontal portion 50. The cover plate 64 may be separately formed from the horizontal portion 50, as shown, and then secured thereto by mechanical fasteners and/or welding. Alternatively, the cover plate 64 may be unitary with the horizontal portion 50. It is also within the scope of the present invention for the cover plate 64 to be left off.

Preferably, the brackets 34 are constructed of metal such as, but not limited to, stainless steel, because of its durability, strength and availability, as well as its ability to be cut, joined, stamped, welded and/or forged in predetermined shapes.

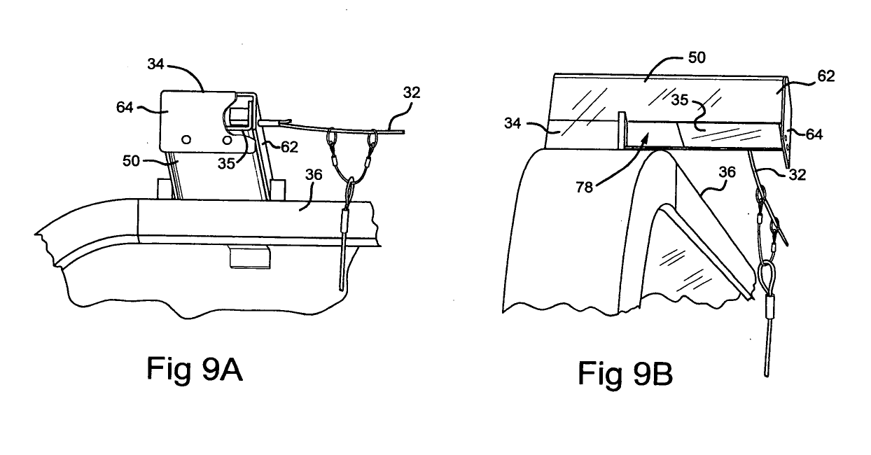

An alternative embodiment, shown in FIGS. 9A & 9B, for the horizontal portion 50 of the bracket 34 comprises a structure 35 having a complimentary shape to the horizontal portion 50. The structure 35 may fit within the horizontal portion 50 to reinforce the horizontal portion 50. By way of example, if the horizontal portion 50 is substantially C-shaped, the complimentary structure 35 may also have a C-shaped design. The present invention may also be used without structure 35.

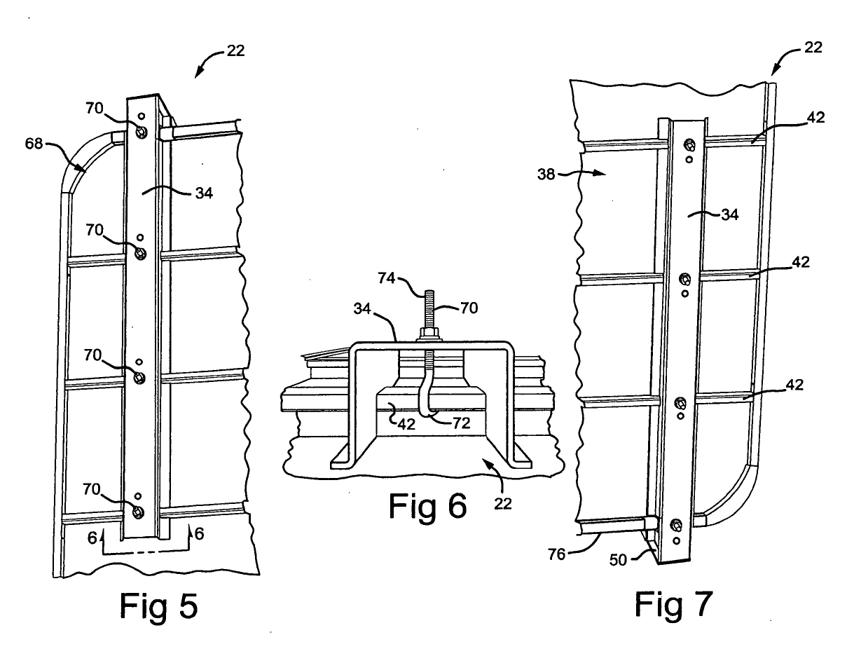

FIG. 5 depicts a close up view of one of the brackets 34 located near an upper rear corner 68 of the billboard 22. A plurality of mechanical fasteners 70 is located through the apertures 58 in the back portion 52 of the bracket 34. Nuts and washers are located on the ends of the fasteners 70.

FIG. 6 shows one embodiment how the mechanical fasteners 70 secure the brackets 34 to the horizontal ribs 42 of the billboard 22. The mechanical fasteners 70 may be such as J-type bolts. The hook end 72 of the bolt 70 preferably extends about and into the rib 42 created by the two joined C-shaped channels. The nut and washer on the threaded end 74 of the fastener 70 can be tightened down so as to pull the bracket 34 into secure contact with the rear portion 38 of the billboard 22.

FIG. 7 shows an alternative embodiment to extending the bracket 34 downwardly from an upper edge 36 of the billboard 22. In FIG. 7, the same bracket 34 described above is turned over so that the horizontal portion 50 extends beneath the lower edge 76 of the billboard 22. The bracket 34 thus extends from the lower edge 76 upwardly along the rear portion 38 of the billboard 22. The bracket 34 in this embodiment is secured to the ribs 42 of the billboard 22 in the same manner described above.

It can be appreciated that a set of brackets 34 extending from the upper edge 36 can be combined with a set of brackets 34 extending from the lower edge 76.

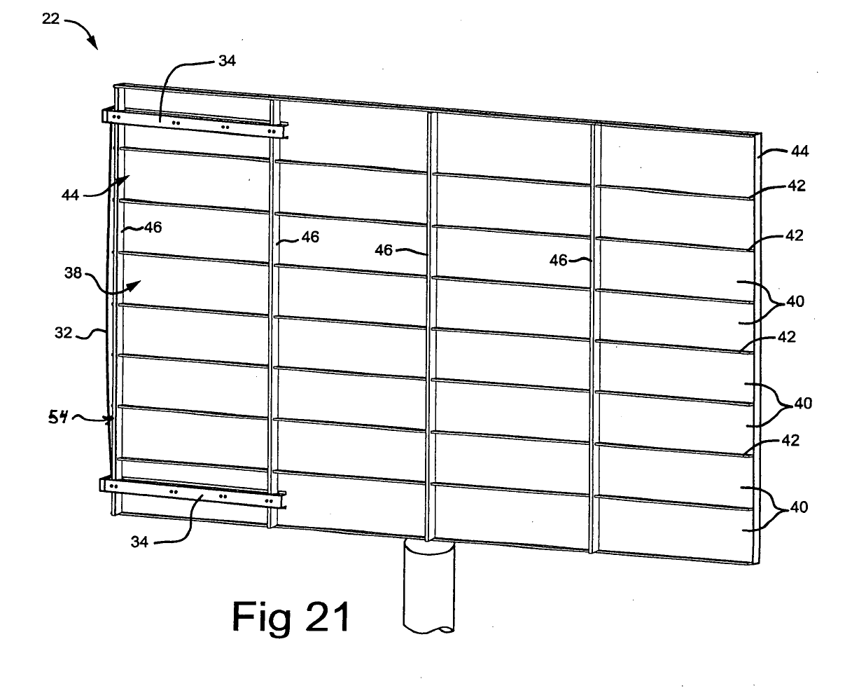

It is also within the scope of the present invention to secure the brackets 34 to the side portions 44 of the billboard 22. As shown in FIG. 21, in this embodiment, the brackets 34 may attach to the vertical sprits 46 as with the horizontal ribs 42 described herein.

The brackets 34 may be attached to the vertical sprits 46 as shown, or the brackets 34 may be attached to additional vertical sprits 46, which are not shown but which can be readily appreciated by those skilled in the art. The brackets 34 may be separated from one another as shown, or the gap between them may be reduced by any amount. Additional brackets 34 may be used.

Regardless of the location or number of brackets 34, a line 32 is connected to the brackets 34 to function in the manner as described herein.

While the brackets 34 are only shown on one side of the billboard 22, the present invention also includes locating them on the opposite side or on both sides of the billboard 22. The present invention also includes brackets 34 located on the top, bottom and/or sides of the billboard 22.

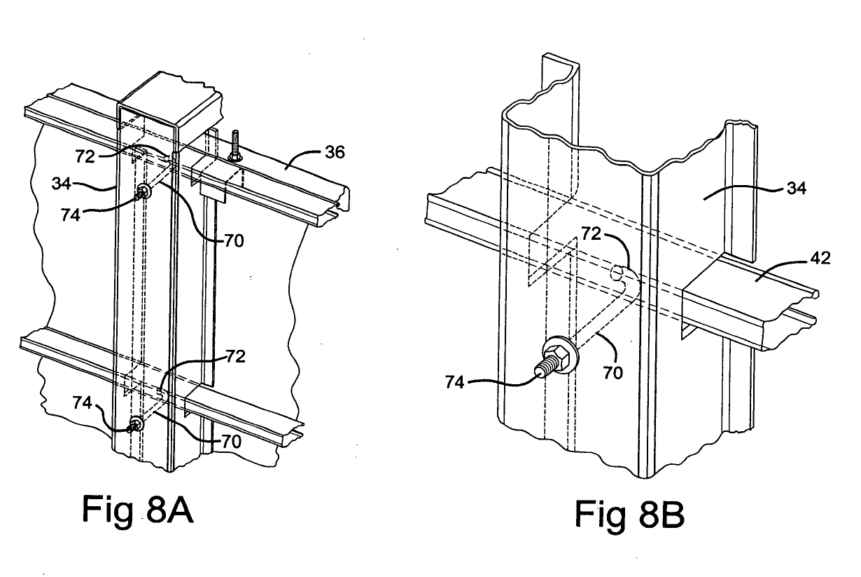

FIGS. 8A and 8B depict details of the bracket 34 extending down from the upper edge 36. From FIG. 8A, two J-type bolts 70 can be seen having one end 74 attached to the bracket 34 and the other end 72 engaged with the horizontal ribs 42 of the billboard 22.

FIG. 8B shows a detail of one of the bolts 70 of FIG. 8A engaged with one of the ribs 42. FIG. 8B also clarifies how the horizontal rib 42 continuously extends through the bracket 34.

While the figures depict the hook end 72 of the bolt 70 extending upwardly, it is also possible for the hook end 72 to extend downwardly to engage with a complimentary-shaped rib 42.

FIGS. 9A and 9B depict the horizontal portion 50 of one of the brackets 34 extending above the upper edge 36 of the billboard 22. In the depicted embodiment, a gap 78 exists between the upper edge 36 of the billboard 22 and the horizontal portion 50. In other embodiments, the gap 78 may or may not exist; if it does exist, then it may be of a length greater than or less than the depicted gap 78. For example, the gap 78 may be made smaller by increasing the depth of the horizontal portion 50 such that the vertical portion 48 is located more deeply into the horizontal portion 50.

FIGS. 9A and 9B also clarify that the second line 32 extending along the upper edge 36 of the billboard 22 is mechanically secured to at least one of the downwardly extending portions 62 of the horizontal portion 50 of the bracket 34. It is within the scope of the present invention to secure the line 32 with methods other than as shown in these figures, but regardless of the method used, it is preferred that the line 32 is securely attached thereto. The line 32 may be selectively removable from the bracket 34 for maintenance, repair and/or replacement.

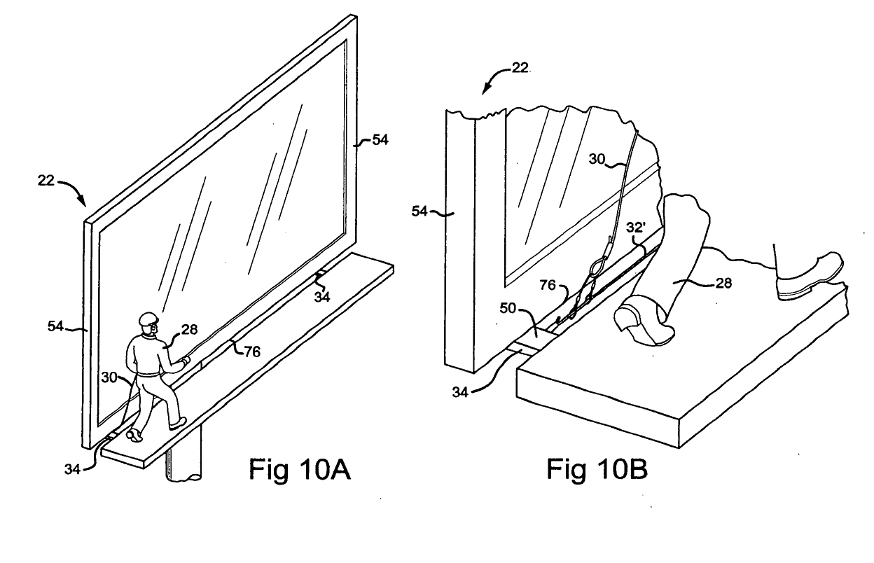

FIGS. 10A and 10B depict an alternative embodiment of the present invention that is consistent with FIG. 7. In FIGS. 10A and 10B, the bracket 34 is mounted to the billboard 22 such that the horizontal portion 50 extends perpendicularly from a lower edge 76 of the billboard 22. A second line 32′ is mechanically secured from one bracket 34 on one side 44 of the billboard 22 to a bracket 34 on the other side 44 of the billboard 22, as described above. As with the above described embodiment, a worker 28 can attach the first line 30 to this line 32′. The second line 32′ may be substantially the same as second line 32 except for a change in location.

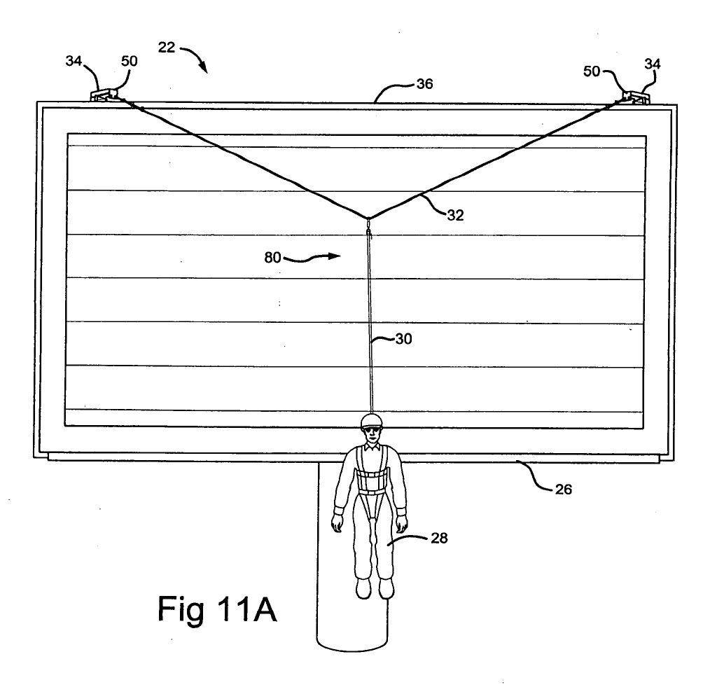

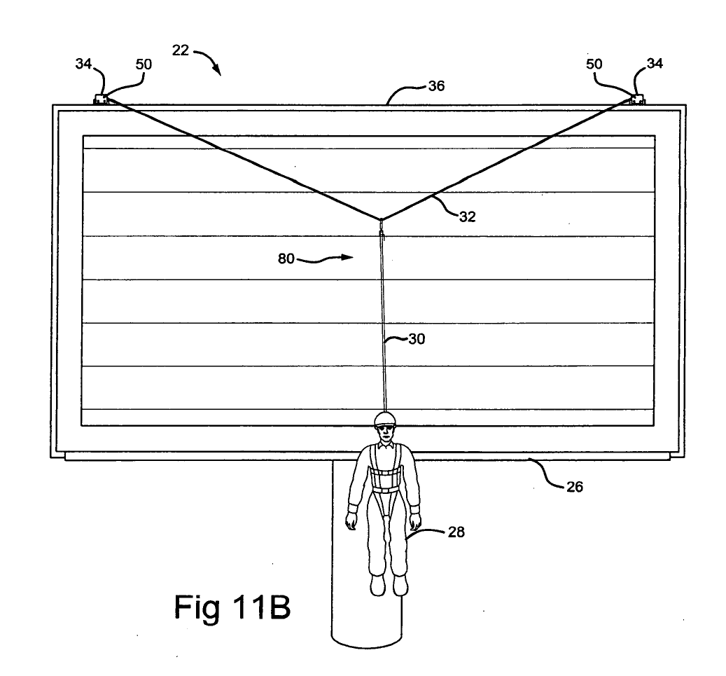

Turning now to FIG. 11A, a worker 28 is depicted as having fallen from a walk surface 26, ladder or other structure used to support the worker 28 above the ground. The worker 28 has attached the first line 30 to the second line 32, which is in this case located along the upper edge 36 of the billboard 22.

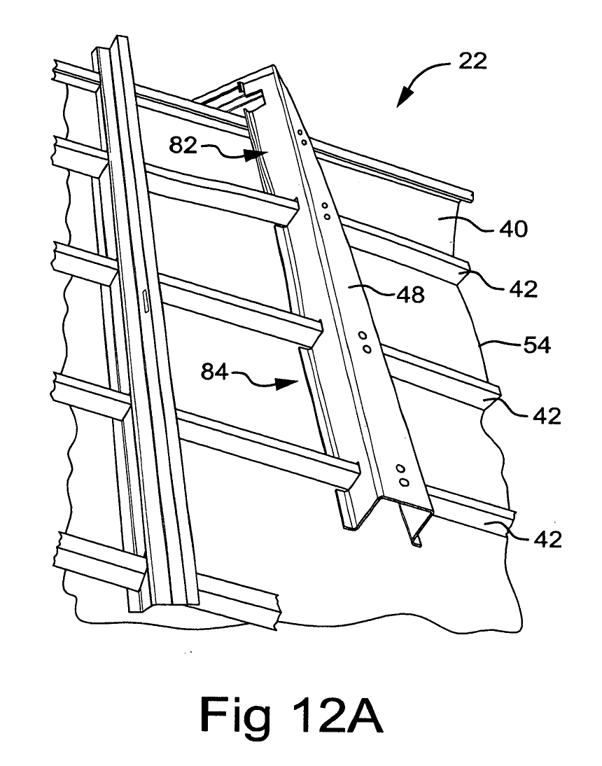

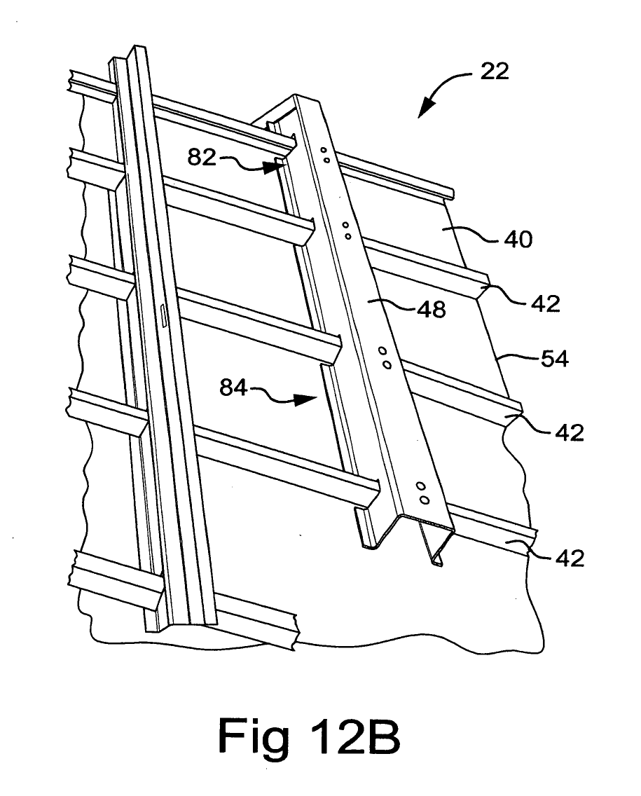

The brackets 34 at the upper edge 36 of the billboard 22 in this case have moved such that the horizontal portions 50 of the brackets 34 are no longer substantially perpendicular to the billboard front portion 20. Instead, the horizontal portions 50 of the brackets 34 are turned inwardly at an angle. The horizontal portions 50 of the brackets 34 have moved when the worker 28 fell, thus absorbing some, or all, of the energy of the worker's fall. The bracket 34 movement may comprise flexing and/or deformation (plastic and/or elastic). The present invention also comprises no flexing and/or deformation of any kind of the brackets 34. See, for example, FIGS. 11B and 12B discussed below.

It can be appreciated that while only a single worker is depicted, the present invention as described herein works equally well with one or more workers being similarly and simultaneously attached to the billboard 22.

In certain cases, the billboard 22 can also be permitted to move, flex and/or deform (plastic or elastic) inwardly toward the fallen worker 28 to further absorb some, or all, of the energy of the worker's fall. For example, one or more of the horizontal panels 40 may permit a predetermined amount of movement, flexure and/or deformation (plastic or elastic) to assist in absorbing energy from such a fall. The present invention also comprises no movement, flexure and/or deformation of any kind by the billboard 22, which is described below.

FIG. 12A depicts one of the brackets 34 of FIG. 11A wherein it can be appreciated that the vertical portion 48 of the bracket 34 has been moved and/or deformed. For example, the upper portion 82 of the bracket 34 may move slightly inward toward a center portion 80 (see FIG. 11A) of the billboard 22 while a lower portion 84 of the bracket 34 may move slightly outward toward the nearest side portion 54 of the billboard 22. It is also within the scope of the present invention that only the upper portion 82 of the bracket 34 has any movement while the lower portion 84 remains substantially stationary.

It is a discovery of the present invention that the J-fasteners 70 used to secure the brackets 34 to the ribs 42 of the billboard 22 may slide slightly along the ribs 42 a predetermined distance until each J-fastener 70 reaches a particular angle with respect to its respective rib 42. At that predetermined distance and angle, the J-fastener 70 locks with its respective rib 42, and does not permit the bracket 34 to move anymore. The sliding and locking action of the brackets 34 absorbs some, or all, of the energy from a falling worker 28.

Separately from, or in addition to, the sliding action described above, the brackets 34 also may twist when exposed to the weight of a fallen worker 28. For example, as shown in FIG. 12A, the upper portion 82 of the bracket 34 has twisted with respect to the lower portion 84. The twisting action of the brackets 34 absorbs some or all of the energy from a falling worker 28.

FIGS. 11B and 12B depict another embodiment of the present invention comprising all of the structure of the preceding figures except that when a worker 28 falls, neither the brackets 34 or the billboard 22 moves. Instead, both the brackets 34 and the billboard 22 remain in a substantially static condition under the weight of a worker, as shown, or even under the weight of more than one worker.

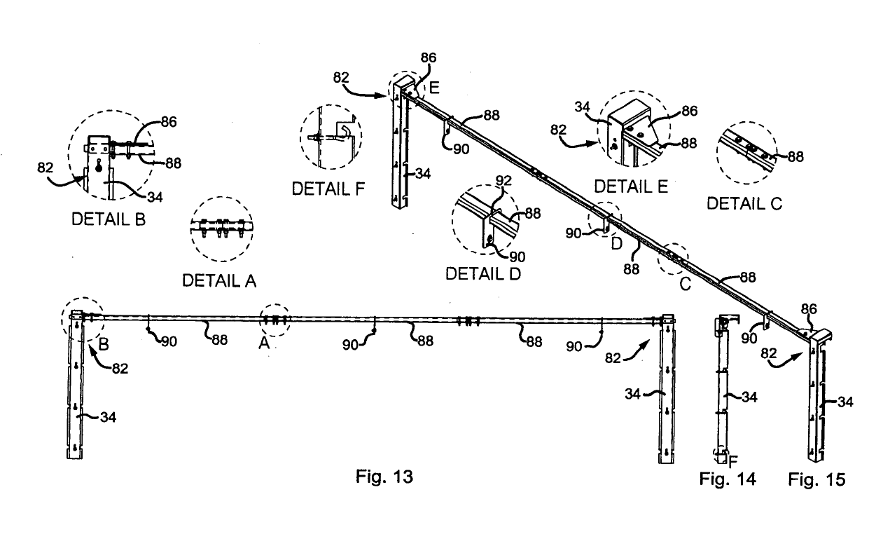

Yet another embodiment of the present invention is depicted in FIGS. 13-20 and their associated details. In this embodiment bracket 34 is provided with reinforcement plate 86. The reinforcement plate 86 is preferably attached to the upper portion 82 of the bracket 34. The reinforcement plate 86 may be attached by any means including, but not limited to, mechanical fasteners and/or welding, to the upper portion 82. The reinforcement plate 86 may also be integrally formed with the upper portion 82 of the bracket 34.

In the depicted embodiment, the reinforcement plate 86 is depicted as being attached on a side of the upper portion 82 of the bracket. The reinforcement plate 86 however may be attached anywhere to the upper portion 82 of the bracket 34, including the horizontal portion 50.

A tube 88 is attached to the reinforcement plate 86. The tube 88 may be attached by mechanical fasteners and/or welding to the reinforcement plate 86. Alternatively, the tube 88 may be unitary and integrally formed with the reinforcement plate 86.

The tube 88 preferably extends from one bracket 34 to the other bracket 34. The tube 88 may be continuous or it may be comprised of a series of pieces, such as shown in the figures. When the tube 88 is comprised of pieces, the pieces may be secured together by mechanical fasteners and/or welding.

As shown in detail D, the tube 88 is preferably supported by a sprit plate 90. The sprit plate 90 may be mechanically or otherwise secured to a vertical sprit 46 as described above. The sprit plate 90 has an aperture 92 for receiving the tube 88 therein and therethrough so that the tube 88 can pass uninterrupted through the plate 90. More than one sprit plate 90 maybe used to support the tube 88 across the entire length of the billboard 22.

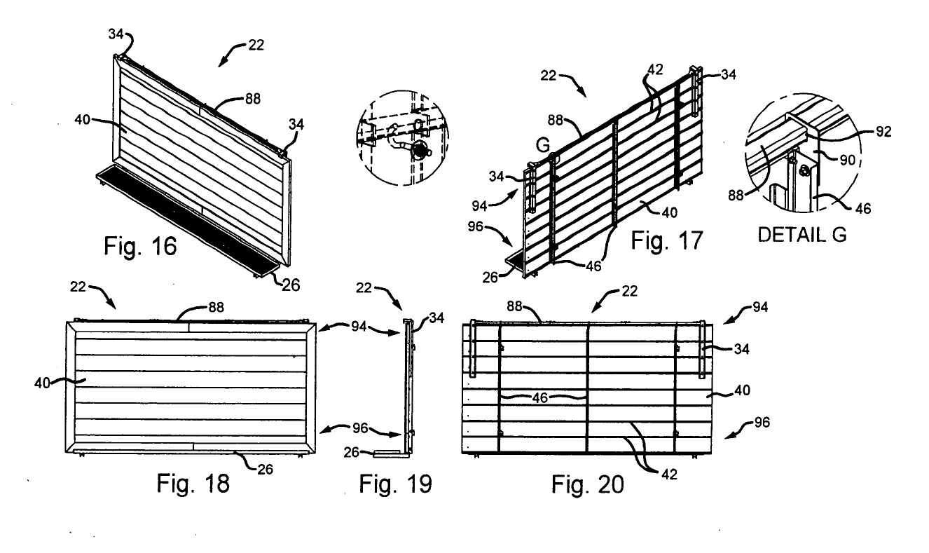

FIGS. 16-20 depict one embodiment of the reinforcement plate 86, the tube 88 and the sprit plates 90 installed on a billboard 22. FIGS. 16-20 depict these structure installed on an upper portion 94 of the billboard 22. The present invention, however, may be located on a lower portion 96 of the billboard 22, a side portion 54 of the billboard 22 and/or the upper portion 94 of the billboard 22 without limitation.

The brackets 34, the reinforcement plate 86, the tube 88 and the sprit plates 90 provide for a very strong billboard 22. When attached to the billboard 22, these structures comprise a billboard system that can support the weight of at least one, and even many, workers if the worker(s) falls from the billboard 22 while secured thereto using any of the structures described above.

This embodiment of the invention may entirely prevent any movement or deformation by the billboard 22 or any of the structures described above under the weight of a worker or workers. Alternatively, the invention may be designed such that it permits a predetermined amount of nonpermanent movement or elastic deformation of one or all of the components described above if a worker or workers were to fall from the billboard 22. This movement or deformation could be of any amount or degree and may be helpful in preventing or minimizing shock to a worker or workers upon a fall.

It should be readily appreciated that the structure described above, can also be used with the embodiment depicted in FIG. 21.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A fall arrest system, comprising:
a billboard having a perimeter, said billboard comprising:
at least two ribs extending horizontally substantially across a rear surface of said billboard,
at least two sprits extending vertically across said rear surface;
at least a first bracket and a second bracket, each bracket comprising:
a horizontal portion extending substantially perpendicularly beyond said perimeter,
a vertical portion connected to said horizontal portion, said vertical portion having a plurality of channels formed therein for receiving said at least two ribs;
at least one mechanical fastener extending through said vertical portions of said each of said brackets, each fastener having a portion for slidably engaging at least one of said ribs; and
an arresting line extending from said horizontal portion of said first bracket to said horizontal portion of said second bracket.
